(19) United States
(12) Patent Application Publication
(10) Pub. No.: US 2003/0205279 A1
(43) Pub. Date: Nov. 6, 2003

(54) Hydraulic valve system

(75) Inventors: Siegfried Zenker, Kirchseeon (DE); Thorkild Christensen, Sonderborg (DK)

Correspondence Address: Zarley Law Firm, P.L.C., Capital Square, Suite 200, 400 Locust Street, Des Moines, IA, 50309-2350, US

(73) Assignee: Sauer-Danfoss (Nordborg) A/S, Nordborg (DK)

(21) Appl. No.: 10/422,519

(22) Filed: Apr. 24, 2003

(30) Foreign Application Priority Data
May 2, 2002 (DE) 102 19 719.9

(51) Int. Cl. F15B 13/04

(52) U.S. Cl. 137/596.12

(57) ABSTRACT

A hydraulic valve system (1) with a supply connection arrangement, has a high-pressure connection (P) and a low-pressure connection (T), and a working connection arrangement, having two working connections (A, B), which can be connected with a motor, and a directional valve (4) and a compensation valve (9). A compensation valve (9) is arranged after the directional valve (4) in the flow direction and a pressure relief device (43) is arranged between the directional valve (4) and the low-pressure connection (T).

### BACKGROUND OF THE INVENTION

The invention concerns a hydraulic valve system with a supply connection arrangement, having a high-pressure connection and a low-pressure connection, a working connection arrangement, having two working connections, which can be connected with a motor, a directional valve and a compensation valve.

A hydraulic valve system of this kind is known from DE 199 19 015 A1. The compensation valve, which can also be called pressure balance valve or pressure control valve for the directional valve, is arranged in front of the inlet of the directional valve. The compensation valve ensures that a constant differential pressure is always available over the directional valve, that is, the compensation valve controls the supply of the hydraulic fluid to the directional valve in dependence of the opening degree of the directional valve.

A valve system of this kind is often used in a hydraulic system, in which several of such valve arrangements are provided side by side, each valve arrangement controlling its own motor. One example of this is a hydraulically operated backhoe, which has several motors to enable the control of various elements when moving the backhoe shovel. A first motor is provided to control the inclination of a beam. A second motor controls the movement of an arm in relation to the beam, and a third motor controls the movement of the shovel in relation to the arm. When all motors are activated at the same time, it may happen that the capacity of a pump or another supply arrangement, which is supposed to make hydraulic fluid available to the motors, is no longer sufficient. In this case, the operation with the hydraulic valve system gets more difficult.

In recent years, it has become more and more common for backhoes and other machines to be operated by persons, who have very little experience. For example, the market for rental machines is steadily increasing. These machines are rented to laymen.

### SUMMARY OF THE INVENTION

The invention is based on the task of enabling a simple operation of a valve system, which, during simultaneous operation of several valve arrangements, the volume supplied by the supply arrangement is no longer sufficient.

With prior hydraulic valve systems as mentioned above, this task is solved in that the compensation valve is arranged after the directional valve in the flow direction and a pressure relief device is arranged between the directional valve and the low-pressure connection.

When the compensation valve is arranged after the directional valve in the flow direction, this means that the hydraulic fluid is first led through the directional valve, and accordingly is controlled by the directional valve. At the same time, this makes it possible to act upon the compensation valve with the highest load-sensing pressure appearing in the system. This is an upgrading in relation to the possibility known from DE 199 19 015 A1, in which only the highest pressure in the valve arrangement acted upon the compensation valve. When, now, the compensation valve can be acted upon by the highest load-sensing pressure existing in the system, that is the highest pressure in several valve arrangements arranged side by side, this automatically causes a distribution of the available flow of hydraulic fluid to the individual valve arrangements. Accordingly, all the required functions are performed at the same time, namely in the relation set by the user. Due to the insufficient supply, however, these functions are performed slower. Problematic with this embodiment is, however, that there is a risk that small leakages will cause a pressure to be built up, which may, for example, be able to open check valves. The opening of a check valve would then cause that, for example, a load is lifted in an uncontrolled manner. This would lead to dangerous situations. Therefore, the arrangement of the compensation valve after the directional valve is combined with a pressure relief device, which can dissipate a pressure in the system. This prevents that, for example, check valves open in an uncontrolled manner.

The pressure relief device has a controllable connection. Thus, the pressure is only relieved, that is, the leakage fluid is only drained off, when the pressure threatens to get too large. In this case, the controllable connection is opened, more or less, in dependence of the ruling pressure. This measure helps keeping a fluid loss in connection with leakages as small as possible.

Also, the throttle has a control inlet, which is connected with an outlet of the directional valve. The possible leakages will in all probability occur at the outlet of the directional valve. On the one side, the directional valve is connected with the high-pressure connection, that is, here there is a risk of leakage from the high-pressure connection. Further, the directional valve is connected with the working connections. When the working connections are under pressure, for example with a so-called negative load, pressures in the hydraulic fluid also occur here, which may cause a leakage flow of fluid. When, now, this pressure build-up is caught immediately at the outlet of the directional valve, this pressure can easily be dissipated here in a controlled manner.

In addition, the outlet of the directional valve is connected with a first chamber in the directional valve, said chamber lying next to a second chamber in the directional valve, which is connected with the high-pressure connection. In many cases, a directional valve is designed so that a slide is displaceable in a housing. The slide has grooves, which can be brought to overlapping with corresponding grooves, that is, annular recesses in the housing. Such annular grooves then form the chambers. When it is ensured that the outlet of the directional valve is connected with a groove, which is next to the groove connected with the high-pressure connection, this provides with a high probability that occurring leakages can be detected very quickly, that is, the build-up of an overpressure, which could open the check valves, is detected and avoided very quickly.

Further, the pressure relief device is arranged in the compensation valve. This embodiment has the advantage that no additional space is required. The compensation valve thus becomes a second task, namely to cause the pressure relief. Additional tubes and corresponding connections can be avoided, meaning that the production cost will not increase.

It is particularly preferred that the compensation valve has a slide, which, in a first position blocks a passage from an inlet to an outlet of the compensation valve, in a second position opens the passage from the inlet to the outlet and in a third position with blocked passage creates a connection between the outlet and the low-pressure connection, the third position lying between the first and the second position. The use of a compensation valve with a slide, which, depending on the position, opens or blocks a passage between inlet and outlet, is known per se. The term “position” is not to be understood so that the slide of the compensation valve can in fact only assume two positions. In fact, the slide has a first position area, in which the passage between inlet and outlet is blocked, and a second position area, in which the passage is opened with a declining throttling resistance. However, between the first and the second position, an additional third position area is available here, in which the pressure relief can be effected. In this position, the pressure that has built up at the outlet by means of leakages, can very quickly escape to the low-pressure connection. During operation, that is, in the “open position” of the compensation valve, this connection is, however, closed again.

The slide has at least one recess with an extension in the axial direction, which recess is larger than the length of a wall between the outlet and the low-pressure connection, and, in the first position of the slide, ends at a distance from the low-pressure connection, which is not larger than the length of an opening movement of the slide between the first and the second position. Thus, the slide can be displaced to a small degree, namely so that the recess on both sides of the wall between the outlet and the low-pressure connection is released. In this position, a connection between the outlet of the compensation valve and the low-pressure connection is established. However, the connection between the inlet of the compensation valve and the outlet has not yet been established, as the required opening movement of the slide has not yet taken place. The recess in the slide of the compensation valve can, for example, be in the form of a circumferential groove. Preferably, however, grooves extending only in the axial direction will be used, as this gives a relatively high throttling resistance, so that a pressure can be dissipated quickly, fluid losses, however, being avoided.

It is particularly preferred that, in the first position, the slide dives into an opening, which is connected with the inlet, and, in the second position, is retracted from the opening. This is a relatively simple way of providing the opening movement with a length, which permits the arrangement of another intermediary position between the closed and the open position of the slide of the compensation valve, in which intermediary position the outlet is connected with the low-pressure connection. In the second position of the slide, the wall covers the end of the recess next to the outlet. Thus, in the second position any fluid loss in the direction of the low-pressure connection is avoided. This further increases the efficiency of the valve arrangement.

### BRIEF DESCRIPTION OF THE DRAWINGS

FIG. 1 is a schematic drawing of a hydraulic valve system of this invention;

FIG. 2 is a schematic drawing of a first embodiment of a hydraulic valve system of this invention;

FIG. 3 is a schematic drawing of a second embodiment of a hydraulic valve system of this invention; and

FIG. 4 is an enlarged partial sectional view of the compensation valve of this invention.

### DESCRIPTION OF THE EMBODIMENTS OF THE INVENTION

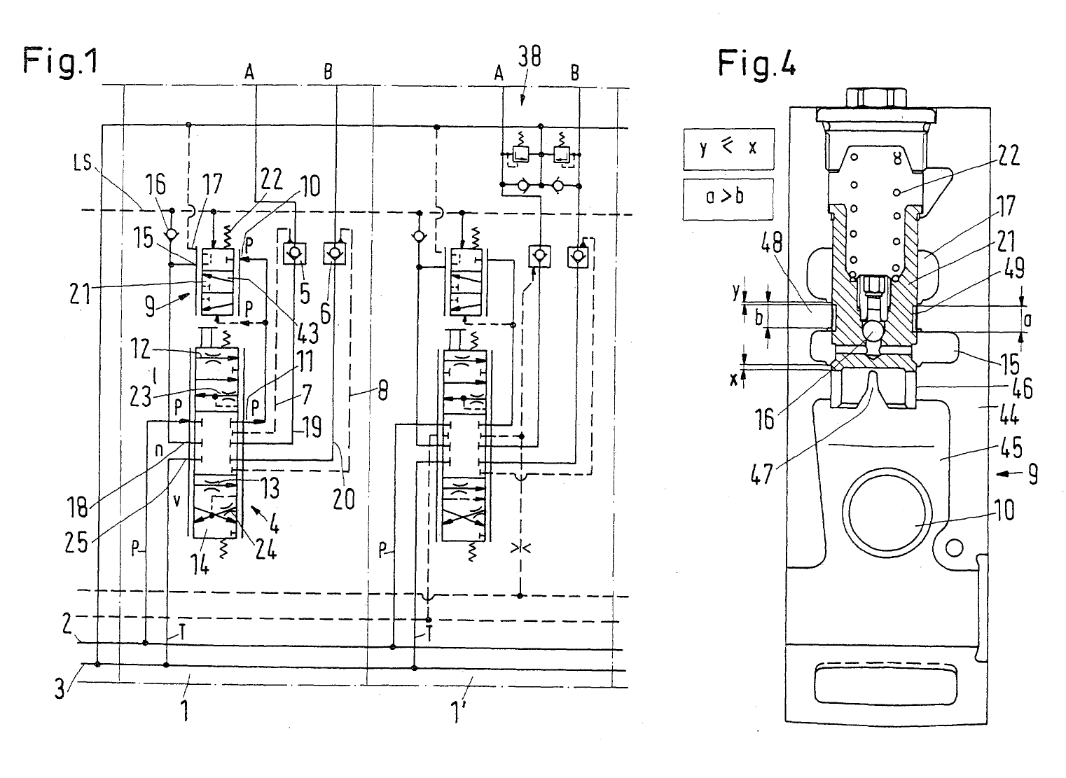

FIG. 1 shows a hydraulic valve system 1, which is parallel-connected with a second hydraulic valve system 1′. Both valve arrangements 1, 1′ have a high-pressure connection P and a low-pressure connection T, the high-pressure connection P and the low-pressure connections T being connected with a pump line 2 or a tank line 3, respectively. Only two valve arrangements 1, 1′ are shown. In practice, often more than two valve arrangements 1, 1′ are arranged in parallel with each other. With regard to essential components, the two valve arrangements 1, 1′ correspond to each other. Therefore, the description is made on the basis of valve arrangement 1.

Together, the high-pressure connection P and the low-pressure connection T form a supply connection arrangement, which serves as inlet and outlet of hydraulic fluid. Further, the valve arrangement 1 has a working connection arrangement with two working connections A, B, a hydraulic motor being connectable to said working connections A, B in a manner not shown in detail. The hydraulic motor can, for example, be a double-acting cylinder.

Between the supply connection arrangement P, T and the working connection arrangement A, B is arranged a directional valve 4. The directional valve 4 can be displaced from the neutral position n shown into a first direction position 1 and a second direction position r, to supply hydraulic fluid to one of the working connections A, B from the high-pressure connection P. The other working connection B, A is connected with the low-pressure connection T. A further explanation follows below.

In each line between the directional valve 4 and the working connections A, B is arranged a check valve 5, 6, the check valves 5, 6 being in the form of non-return valves, which can be opened via the control lines 7, 8. The directional valve 4 also controls the pressure in the control lines 7, 8.

A compensation valve 9 is provided to keep a pressure over the directional valve 4 substantially constant. Therefore, it is also called pressure control valve or pressure balance valve. The compensation valve 9 has an inlet 10, which is connected with an outlet 11 of the directional valve 4. In the neutral position n of the directional valve 4 shown, the outlet 11 is connected with no further connection. As soon as the directional valve 4 is displaced to one of the two other positions 1, r, the outlet 11 of the directional valve 4 is connected with the high-pressure connection P, a throttle 12, 13 being arranged in the connection. The oil amount through the throttles 12, 13 depends on the position of the slide 14 of the directional valve.

The compensation valve 9 has an outlet 15, which is connected with a load-sensing line LS via a non-return valve 16. The non-return valve 16 ensures that the load sensing line LS always receives the highest pressure at all outlets 15 of the compensation valves 9 of all valve arrangements 1, 1′. The compensation valve 9 further has a tank outlet 17, which is connected with the low-pressure connection T.

The outlet 15 of the compensation valve 9 is connected with an inlet 18 of the directional valve, the inlet 18 being, in dependence of the position of the slide 14 of the directional valve 4, connected with one of the lines 19, 20, leading to the working connections A, B.

The compensation valve 9 has a slide 21, which is in one direction (closing direction) acted upon by the force of a spring 22 and the pressure in the load-sensing line LS. In the other direction (opening direction), the pressure at the outlet 11 of the directional valve 4 acts upon the slide 21.

The line 19, 20, which is not connected with the inlet 18 of the directional valve 4 at a certain position of the slide 14 of the directional valve 4, is connected via a throttle 23, 24 in the slide 14, with a tank inlet 25 of the directional valve, which is in connection with low-pressure connection T.

The valve arrangement 1 works as follows:

When the slide 14 is displaced to, for example, the position 1, hydraulic fluid under pressure from the high-pressure connection P reaches the inlet 10 of the compensation valve 9 via the outlet 11. At the same time, the pressure reaches the slide 21 and moves the slide 21 to an open position of the compensation valve 9, in which the inlet 10 is connected with the outlet 15. An additionally shown intermediary position of the compensation valve 9 is explained below.

From the outlet 15, the hydraulic fluid under pressure reaches the inlet 18 of the directional valve and from here, via the line 19, to the working connection A. The pressure in the line 19 opens the check valve 5. The check valve 6 in the other line is opened via the control line 8, whose pressure corresponds to the pressure at the low-pressure connection T.

Over the slide 21 of the compensation valve 9 there is a pressure difference between the pressure in the load-sensing line LS and the pressure at the outlet 11 of the directional valve 4. Additionally, the force of the spring 22 acts here. The slide 21 of the compensation valve 9 thus adjusts so that a constant pressure difference rules over the directional valve 4. The fact that the compensation valve 9 is arranged after the directional valve 4 in the flow direction makes it possible to act upon all compensation valves with the same load-sensing pressure, that is, the pressure in the load-sensing line LS. This gives the advantage that a flow distribution can be realised, that is, the motors connected to the valve arrangements 1, 1′ can also be operated, when the amount of hydraulic fluid supplied at the pump line 2 is no longer sufficient to cover the need of all motors. This method, also called “flow divider” or “flow sharing”, then causes that the motors, that is, the working connection arrangement A, B, is supplied with a reduced fluid amount, the distribution of the fluid amount corresponding to the positions of the directional valves 4. The machine, which is controlled by the valve arrangements 1, 1′, then basically works as desired by the user. The only limitation is that the functions are performed a little slower.

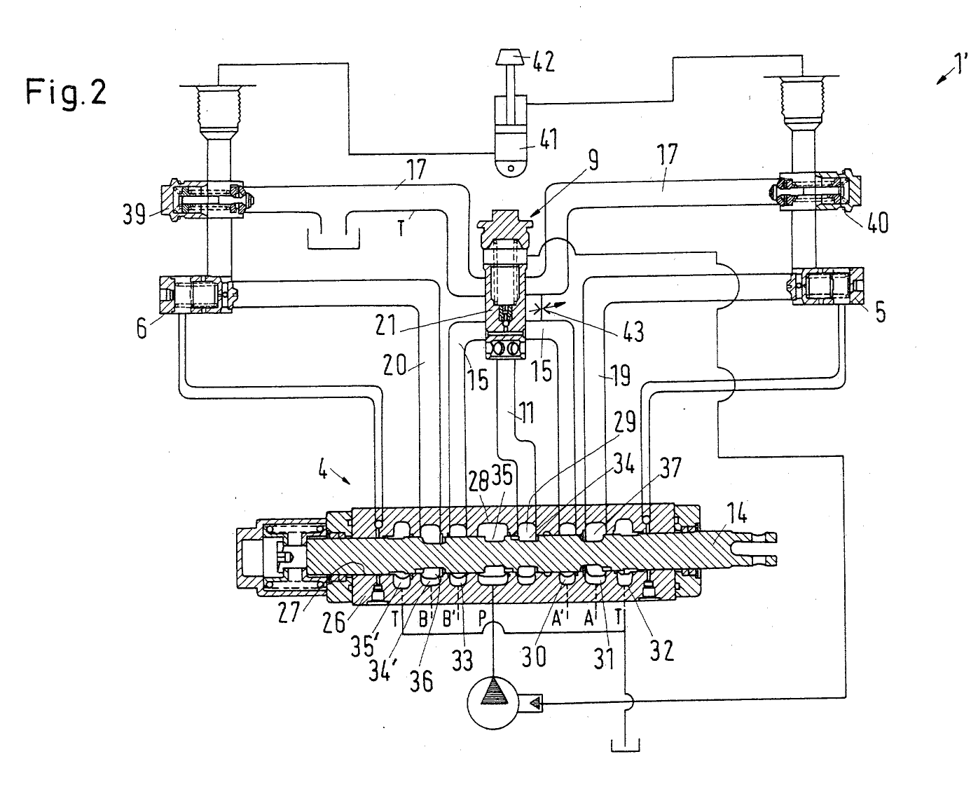

FIG. 2 shows the valve arrangement 1′ in a more detailed view. The same parts as in the valve arrangement 1 in FIG. 1 have the same reference numbers.

It can be seen that the directional valve 4 has a housing with a bore 27, which is provided with a number of grooves 28 to 33, 34′, 35′. The slide 14 has a number of recesses 34 to 37, which, at a corresponding displacement of the slide 14 in the housing 26, connect certain neighbouring grooves with each other. When, for example, the slide 14 is displaced to the right, the recess 35 connects the grooves 28, 29. The recess 37 connects the grooves 31, 32 and the recess 36 connects the grooves 33, 34′. Fluid supplied from the high-pressure connection P to the groove 28 flows via the compensation valve 9, whose slide 21 is opened by the pressure in the line 11, into the two grooves 30, 33 and via the recess 36 to the working connection B. From the working connection A, the hydraulic fluid is then returned to the low-pressure connection T via the groove 31, the recess 37 and the groove 32. In this connection, the check valves 5, 6 are opened by the ruling pressures or a connection (not shown in detail) with the low-pressure connection T, respectively.

An anti-cavitation valve arrangement 38 with valves 39, 40 shown at the valve arrangement 1′ in FIG. 1 will not be explained in detail.

In the valve arrangement 1, 1′ shown in FIGS. 1 and 2, a small leakage can eventually cause an impermissible pressure to be built up in the lines 19, 20. This pressure may cause the check valves 5, 6 to open. This is particularly the case, when the slide 14, as shown in FIGS. 1 and 2, is in the neutral position n. When the check valves 5, 6 open because of a pressure in the lines 19, 20, a load 42 lifted by the motor 41 would in principle be further lifted, which could cause dangerous situations.

In order to prevent this, a pressure relief device in the form of a throttle 43 is provided, which connects a bridge line 44 with the tank outlet 17 of the compensation valve 9. For reasons of clarity, FIG. 2 shows the throttle 43 outside the compensation valve 9. As can be seen from FIG. 4, however, the throttle is arranged inside the compensation valve. It is formed by the cooperation of the slide 21 with the housing 44 of the compensation valve 9. The throttle 43 forms a constant connection between the two branches, that is, between the outlet 15 of the compensation valve and the tank outlet 17.

For reasons of clarity, the letter “p” appears several times in FIG. 1, to show how the pressure can build up in connection with leakages. When this pressure gets large enough, the slide 21 relatively quickly switches to the intermediary position shown in FIG. 1 and connects the pressure with the tank, which effects a pressure relief.

The embodiment of the recesses 49 makes it possible to control the throttling characteristic of the throttle 43 and thus the relief behaviour of the pressure relief device formed by the throttle 43.

When, as shown in FIG. 2, the grooves 30, 33 are relieved via the throttle 43, that is, the recess 49 and the wall 48, also the relief of the grooves 31, 34 is achieved. This makes it possible to achieve a relief even with a very small leakage. When, without the specially designed compensation valve 9, an error occurs on closing the check valves 5, 6, it would be necessary to accept, for example, a leakage of about 400 to 500 cm³/min at a supply pressure of 200 bars. With the new design, a normal tightness can be maintained at the slide 14 of the directional valve 4, and the fluid loss can be reduced to about 20 to 25 cm³/min at 200 bars supply pressure.

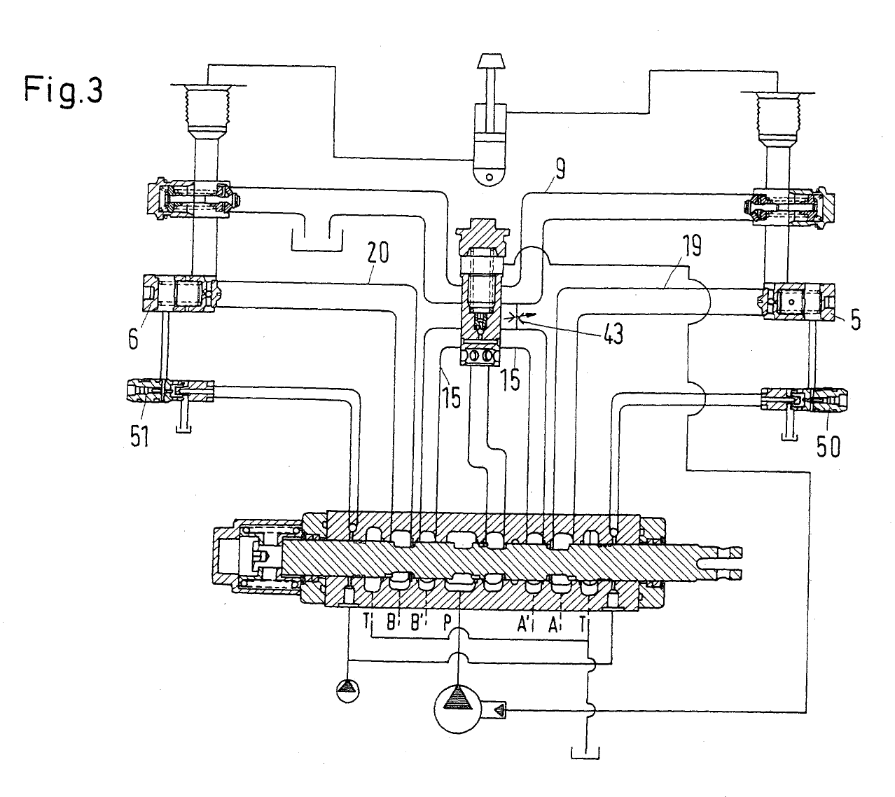

FIG. 3 shows a modified embodiment, in which the same parts have the same reference numbers. The main change is that the check valves 5, 6 are pre-controlled by pilot valves 50, 51. Also with this embodiment the throttle 43 offers a relief between the outlet 15 of the compensation valve 9 and the tank outlet 17, so that a pressure, which could open the check valves 5, 6, cannot occur in the lines 19, 20.

In FIG. 4 the elements corresponding to those in FIG. 1 have the same reference numbers.

The inlet 10 is connected with a pressure chamber 45, which ends in a bore 46, into which the lower end of the slide 21 dives. To produce a connection between the inlet and the outlet 15, the slide 21 must be moved by a distance x. At the end diving into the bore 46, the slide has steering openings 47, which determine the throttling resistance in the connection between the inlet 10 and the outlet 15 in dependence of the position of the slide 21 in the housing 44.

The outlet 15 is separated from the tank outlet 17 by a wall 48, which has a length b in parallel with the movement direction of the slide 21.

On its circumference, the slide 21 has several recesses 49, whose length a is larger than the thickness b of the wall. It is favourable, when at least two recesses 49 are provided. However, also more than two recesses 49 can be used. At any rate, the recesses 49 should be provided in such a way that the forces on the slide 21 are distributed symmetrically.

In the closed position of the slide 21 shown, the end of the recesses 49 next to the tank outlet 17 is a distance y away from the tank outlet 17. The distance y is smaller than or equal to the distance x, that is, when the slide 21 moves, the recess 49 initially gets in contact with the tank outlet 17, before the connection between the inlet 10 and the outlet 15 is opened. Simultaneously with the connection of the recess 49 (or recesses), the outlet 15 is connected with the tank outlet 17, as the axial length of the recess 49 is larger than the thickness of the wall 48. A movement of the slide 21 will thus provide a brief connection between the outlet 15 and the tank outlet 17, before a connection between the inlet 10 and the outlet 15 is established. However, as soon as the slide 21 is further displaced, the connection between the outlet 15 and the tank outlet 17 is interrupted again, and merely a connection between the inlet 10 and the outlet 15 exists. Thus, the slide 21 has, for a short duration, a third position, which is shown schematically in FIG. 1. This position is between the first position, in which the connection between the inlet 10 and the outlet 15 is interrupted, and the second position of the slide 21, in which the connection between the inlet 10 and the outlet 15 has been established.

It is therefore seen that this invention will achieve all of its intended objectives.

What is claimed is:

1. A hydraulic valve system with a supply connection arrangement, having a high-pressure connection and a low-pressure connection, a working connection arrangement, having two working connections, which can be connected with a motor, a directional valve and a compensation valve, characterised in that the compensation valve (9) is arranged after the directional valve (4) in the flow direction and a pressure relief device (43) is arranged between the directional valve (4) and the low-pressure connection (T).

2. The valve system according to claim 1, characterised in that the pressure relief device has a controllable connection (43).

3. The valve system according to claim 2, characterised in that the throttle (43) has a control inlet, which is connected with an outlet (11) of the directional valve (4).

4. The valve system according to claim 3, characterised in that the outlet (11) of the directional valve (4) is connected with a first chamber (29) in the directional valve (4), said chamber (29) lying next to a second chamber (28) in the directional valve (4), which is connected with the high-pressure connection (P).

5. The valve system according to claim 1, characterised in that the pressure relief device (43) is arranged in the compensation valve (9).

6. The valve system according to claim 5, characterised in that the compensation valve (9) has a slide (21), which, in a first position blocks a passage from an inlet (10) to an outlet (15) of the compensation valve (9), in a second position opens the passage from the inlet (10) to the outlet (15) and in a third position with blocked passage creates a connection between the outlet (15) and the low-pressure connection (T), the third position lying between the first and the second position.

7. The valve system according to claim 6, characterised in that the slide (21) has at least one recess (49) with an extension (a) in the axial direction, which is larger than the length (b) of a wall (48) between the outlet (15) and the low-pressure connection (T), and, in the first position of the slide (21), ends at a distance (y) from the low-pressure connection (T), which is not larger than the length (x) of an opening movement of the slide (21) between the first and the second position.

8. The valve system according to claim 7, characterised in that, in the first position, the slide (21) dives into an opening (46), which is connected with the inlet (10), and, in the second position, is retracted from the opening (46).

9. The valve system according to claim 7, characterised in that, in the second position of the slide (21), the wall covers the end of the recess (49) next to the outlet (15).
